(19) United States
(12) Patent Application Publication
(10) Pub. No.: US 2013/0033387 A1
(43) Pub. Date: Feb. 7, 2013

(54) SYSTEM AND METHOD FOR RECEIVING AND ANALYZING TEXT-BASED MESSAGES IN AN AIRCRAFT

(71) Applicant: Mitchell S. Trope, Olathe, KS (US)

(72) Inventor: Mitchell S. Trope, Olathe, KS (US)

(73) Assignee: GARMIN INTERNATIONAL, INC., Olathe, KS (US)

(21) Appl. No.: 13/195,512

(22) Filed: Aug. 1, 2011

(51) Int. Cl. G01C 23/00

(52) U.S. Cl. 340/971

(57) ABSTRACT

A system for receiving controller pilot data link communications (CPDLC) in an aircraft comprises a radio for receiving CPDLC messages transmitted by a plurality of remote radio systems; a processing system for determining which of the CPDLC messages are intended for a target remote radio system; and a display for displaying the CPDLC messages intended for the target remote radio system in association with an identifier for the target remote radio system.

### BACKGROUND

Communications between aircraft and ground stations have historically been over voice channels. Voice communications require all aircraft radio systems in an air traffic control sector to be tuned to the same frequency, causing pilots to occasionally talk over one another. In some sectors, the voice communications may be so frequent that time available for communication is extremely limited. Voice communications are also sometimes difficult to interpret, thus requiring some communications to be repeated. Voice communications may be difficult to interpret if more than one radio system transmitter is active on a given frequency.

Many aircraft and ground stations are becoming equipped with radio systems for transmitting and receiving text-based messages over digital data links. The exchange of these text-based messages is commonly referred to as controller pilot data link communications (CPDLC).

### SUMMARY

Embodiments of the present technology provide a system and method for receiving and analyzing text-based messages in an aircraft that permit pilots to enhance their situational awareness of issues being faced by other aircraft. An exemplary embodiment of the technology is a system for receiving and analyzing text-based messages in an aircraft that comprises a radio for receiving text-based messages from a plurality of remote radio systems; a processing system for associating received text-based messages with a target remote radio system based on information in the messages; and a user interface for permitting a pilot or co-pilot of the aircraft to monitor the text-based messages intended for the target remote radio system. The system is integrated into the aircraft operated by the pilot or co-pilot. The remote radio systems may be ground stations (e.g., air traffic control, base stations, etc) or other aircraft. The target remote radio system may include a remote radio system that receives communication from another remote radio system. For example, if a text-based message is transmitted by a ground station intended to be received by an aircraft, the aircraft can be the target radio system. Similarly, if a text-based message is transmitted by an aircraft intended to be received by a ground station, the ground station can be the target radio system. In some embodiments, the text in the text-based messages are units of information that may include, but are not limited to, letters, numbers, symbols, or any other representation of text-based information (e.g., binary representation of text-based information). For example, text-based messages may include binary representations of waypoints and a time of arrival associated with the waypoints.

An embodiment of the user interface may include a display that displays the messages intended for the target remote radio system, such as another aircraft, alongside identifiers for the target remote radio system. The identifiers for the other aircraft may be the aircraft's International Civil Aviation Organization (ICAO) addresses, ICAO flight ID, tail number, airline information, graphical representations of positions of the other aircraft, or anything else that permits easy identification of the aircraft. The display may be a touchscreen display that displays the text-based messages intended for target remote radio system when a pilot or co-pilot touches or otherwise selects the representation of the target remote radio system on the display. For example, a pilot or co-pilot may select the representation of a ground station or other aircraft to cause the display to present text-based messages intended for the ground station or other aircraft.

The system may also include memory for storing messages transmitted by the plurality of remote radio systems. For example, the system may store all text-based messages that were intended for one or more aircraft or ground station. The processing system may permit keyword searching of the stored messages so that a pilot or co-pilot can quickly and easily view all messages that relate to a particular keyword such as “turbulence”, “diversion”, “delay”, or the like.

This summary is provided to introduce a selection of concepts in a simplified form that are further described in the detailed description below. This summary is not intended to identify key features or essential features of the claimed subject matter, nor is it intended to be used to limit the scope of the claimed subject matter. Other aspects and advantages of the present invention will be apparent from the following detailed description of the embodiments and the accompanying drawing figures.

### BRIEF DESCRIPTION OF THE DRAWING FIGURES

Embodiments of the present invention are described in detail below with reference to the attached drawing figures, wherein:

FIG. 1 is a block diagram of an exemplary system for receiving and analyzing text-based messages that embodies principles of the present technology.

FIG. 2 is a schematic diagram of several aircraft and a ground station in which the present technology may be implemented.

FIG. 3 is a front elevational view of an exemplary display screen that may be used in the system of FIG. 1.

FIG. 4 is a perspective view of an exemplary aircraft flight deck that may incorporate components of the system of FIG. 1.

FIG. 5 is a block diagram depicting steps in an exemplary method of the present technology.

The drawing figures do not limit the present technology to the specific embodiments disclosed and described herein. The drawings are not necessarily to scale, emphasis instead being placed upon clearly illustrating the principles of the technology.

### DETAILED DESCRIPTION

The following detailed description of embodiments of the present technology references the accompanying drawings. The embodiments are intended to describe aspects of the technology in sufficient detail to enable those skilled in the art to practice the technology. Other embodiments can be utilized and changes can be made without departing from the scope of the claims. The following detailed description is, therefore, not to be taken in a limiting sense. The scope of the present technology is defined only by the appended claims, along with the full scope of equivalents to which such claims are entitled.

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the present technology can include a variety of combinations and/or integrations of the embodiments described herein.

With voice communications, pilots can listen to communications between other aircraft and ground stations and learn about issues that may be relevant to them. For example, voice communications destined for other aircraft may alert a pilot or co-pilot about bad weather, delays, or other issues affecting nearby aircraft. In contrast, CPDLC messages are typically only presented to the pilots of the aircraft for which they are intended and therefore cannot be used by pilots of other aircraft to enhance their situational awareness.

Embodiments of the present technology allow pilots, co-pilots, and other users to benefit from the advantages of text-based messages while maintaining their situational awareness of issues being faced by other aircraft and ground stations. Text-based messages may contain multiple layers of information, wherein at least one layer contains text communicated as a part of the message to the intended recipient. Presenting a text-based message on a display may include presenting a portion of the text within the message. In some embodiments, the text that comprises the message may be presented to a user after it has been processed into an acceptable format. An exemplary embodiment of the technology receives text-based messages transmitted by a plurality of remote radio systems (e.g., ground stations, aircraft, etc) and then associates the received text-based messages with the corresponding remote radio systems. This permits a pilot or co-pilot of an aircraft to monitor the messages communicated between aircraft and ground stations to learn about issues that may be relevant to them. For example, text-based messages that may be received include transmissions from aircraft to aircraft, aircraft to ground station, and ground station to aircraft. In some embodiments, the system can receives text-based messages from another aircraft intended for a ground station or other aircraft and then associates the received text-based message with the ground station and/or other aircraft. Text-based communications intended for other aircraft may alert a pilot or co-pilot about bad weather, delays, or other issues.

The technology may display messages transmitted by remote radio systems on a display screen alongside identifiers for the remote radio systems involved in the communication. The identifiers may be the other aircrafts' ICAO addresses, ICAO flight ID, tail number, airline information, graphical representations of positions of the other aircraft, or anything else that permits easy identification of the aircraft. A pilot or co-pilot may select one or more other aircraft, for example by touching or placing a cursor next to the representation of the aircraft, and display all the messages intended for the selected aircraft.

The technology may also store messages transmitted by remote radio systems and permit later retrieval of the messages. The technology may also permit searching for keywords in the stored messages so that a pilot or co-pilot can quickly and easily locate and view all messages that relate to a particular keyword or phrase such as “turbulence”, “diversion”, “delay”, or the like. Such keyword searching may also be automatically performed on messages as they are received so that messages with selected words or phrases may be viewed immediately. In some embodiments, the system may monitor messages for a keyword or phrase and alert a pilot or user that a message containing the keyword or phrase has been identified. The alert may be aural, visual, or both.

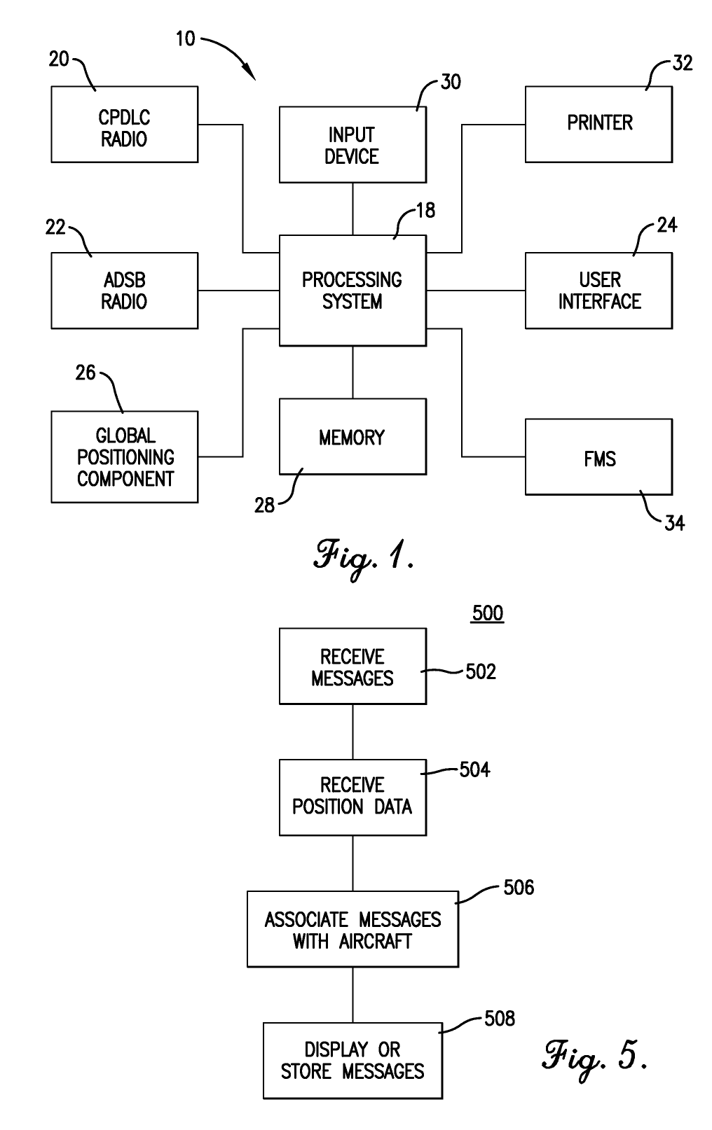

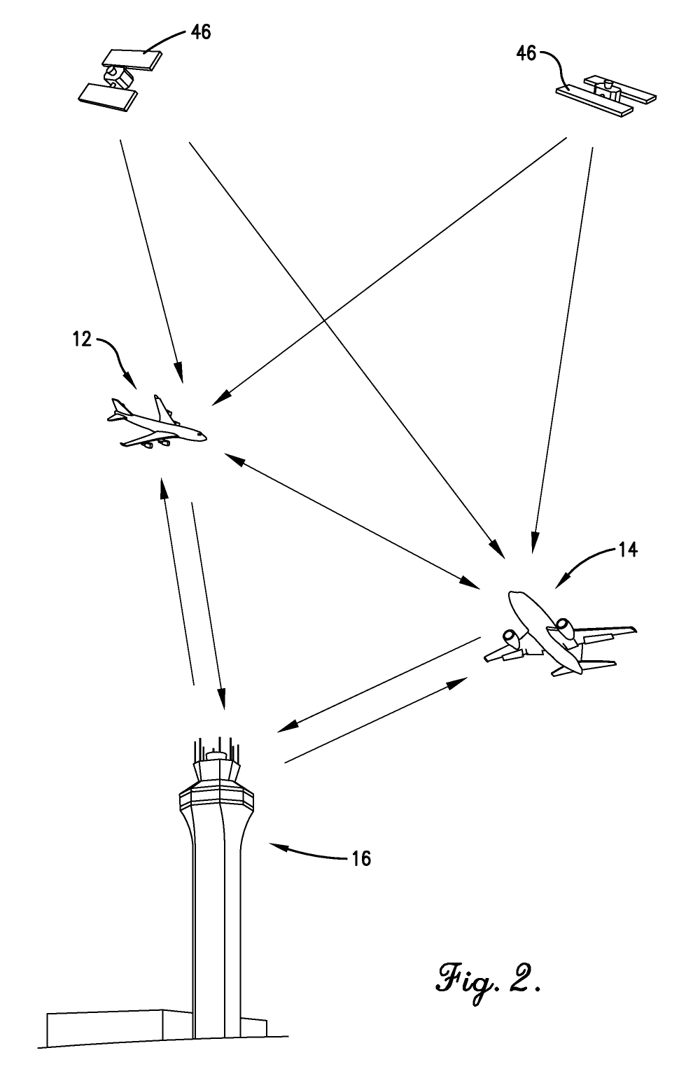

A system embodying the above-described principles and other principles of the present technology is illustrated in FIG. 1 and designated generally by the reference numeral 10. As shown in FIG. 2, the system 10 may be installed in aircraft 12, 14 and used to assist in the receipt and transmission of CPDLC or other text-based messages between the aircraft 12, 14 and one or more ground stations 16 (e.g., air traffic controller station, base station, etc.). While only two aircraft and one ground station are illustrated in FIG. 2, the present technology may be used with any number of aircraft and ground stations.

The system 10 can be implemented in hardware, software, firmware, or a combination thereof. The embodiment of the system 10 shown in FIG. 1 broadly comprises a processing system 18, one or more radios 20, 22, and a user interface 24. Other embodiments of the system 10 may also comprise a global positioning component 26, memory 28, an input device 30, and a printer 32. The system 10 may be a stand-alone system or may be integrated into other avionics systems. The system may be part of, for example, the G1000® avionics suite provided by GARMIN INTERNATIONAL, INC., of Olathe, KS, or similar avionics systems. The system 10 may also be coupled with an aircraft's flight management system (FMS) 34 or other avionics components. In some embodiments, the system may broadly comprise a communications management unit, a radio, and a display. For example, the system may use components as defined in the avionic Standards established by ARINC.

The processing system 18 is operable to receive data from and/or control the operation of the other components of the system 10 and may include any number and type of processors, controllers, or other processing systems. The processing system 18 may include resident or external memory such as the memory 28 for storing data and other information accessed and/or generated by the system 10. The memory 28 may store one or more databases organized and stored to facilitate data access by one or more computer processors, such as the processors associated with the processing system 18. The databases may contain navigational data including, but not limited to, cartographic data including geographic features of the Earth and airport information including designated approach paths. The databases may also store text-based messages, which may be in any storable format, received by the system 10 as described in more detail below.

The processing system 18 may implement one or more computer programs which solve various algorithms and equations and may control the display of information on the user interface 24 as described in more detail below. The computer programs may comprise ordered listings of executable instructions for implementing logical functions in the processing system. The computer programs can be embodied in any computer-readable medium for use by or in connection with an instruction execution system, apparatus, or device, such as a computer-based system, processor-containing system, or other system that can fetch the instructions from the instruction execution system, apparatus, or device, and execute the instructions.

As used herein, a “computer-readable medium” can be any means that can contain, store, communicate, propagate, or transport the programs used with the present technology for use by or in connection with the instruction execution system, apparatus, or device. The computer-readable medium can be, for example, but not limited to, an electronic, magnetic, optical, electro-magnetic, infrared, or semi-conductor system, apparatus, device, or propagation medium. More specific, although not inclusive, examples of the computer-readable medium would include the following: an electrical connection having one or more wires, a portable computer diskette, a random access memory (RAM), a read-only memory (ROM), an erasable, programmable, read-only memory (EPROM or Flash memory), an optical fiber, and a portable compact disk read-only memory (CDROM). An embodiment of the computer-readable medium includes the memory 28.

The radios 20, 22 may include a radio 20 for transmitting and receiving CPDLC or other text-based messages to and from the ground stations 16 and a radio 22 for transmitting and receiving ADS-B position data to and from other aircraft. In some embodiments, the radio 20, 22 may receive text-based messages between aircraft 12, 14. Utilization of position data from the radio 22 may help associate nearby aircraft with CPDLC messages and/or provide supplemental information in addition to that included within the CPDLC messages.

Automatic Dependent Surveillance-Broadcast (ADS-B) is a surveillance technique for air traffic control and related applications. An ADS-B-equipped aircraft determines its own position and periodically broadcasts this position and other relevant information to ground stations and other aircraft with ADS-B equipment. ADS-B equipped aircraft may thus provide an accurate map of nearby air traffic without utilizing radar or complex interrogation methods. It is to be understood that Automatic Dependent Surveillance-Addressed (ADS-A) and Automatic Dependent Surveillance-Contract (ADS-C), or any other text-based message communicated between remote radio systems, may be used to determine the position of aircraft or otherwise enhance situational awareness.

In some configurations radio 22 may comprise a traffic collision and avoidance system (TCAS) radio unit operable to ascertain the location of nearby aircraft. TCAS, and associated methods, enable the identification of nearby aircraft through radio frequency interrogation of nearby aircraft. For instance, a map of nearby aircraft may be developed by using range (determined based on the time required for interrogation and response), altitude (as provided in the interrogation response), and bearing (determined by the aircraft's TCAS antenna). In some embodiments, radio 22 may communicate with a TCAS radio unit in another aircraft to determine how the pilots may avoid a collision. In some configurations, radio 22 may comprise a traffic advisory system (TAS) radio unit operable to determine the presence of nearby aircraft.

The radio 20 may transmit and receive text and data using a digital datalink protocol such as the Aircraft Communications Addressing and Reporting System (ACARS) protocol, the Aeronautical Telecommunications Network (ATN) protocol for Air Traffic Control (ATC) communications, and/or the Internet Protocol (IP) for airline communications. The radio 20 may transmit and receive over any frequency band such as VHF, HF, or SATCOM.

The radios 20, 22 may be separate stand-alone devices, combined into a single radio, and/or be part of other existing communication radios of the aircraft 12, 14. The radios 20, 22 may be switched by a conventional aircraft audio panel.

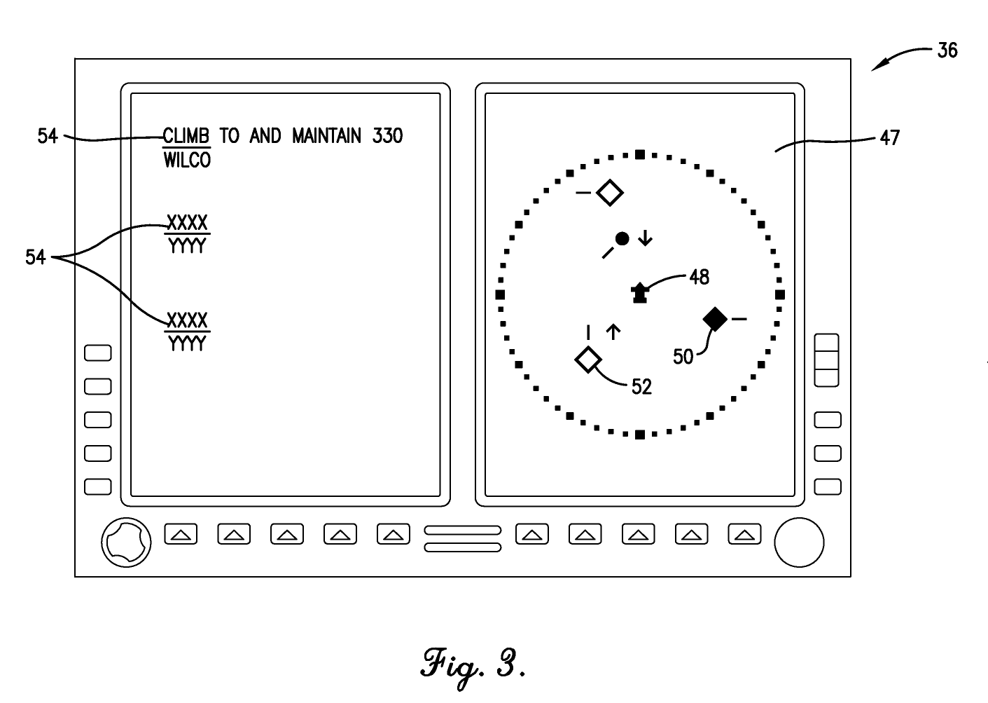

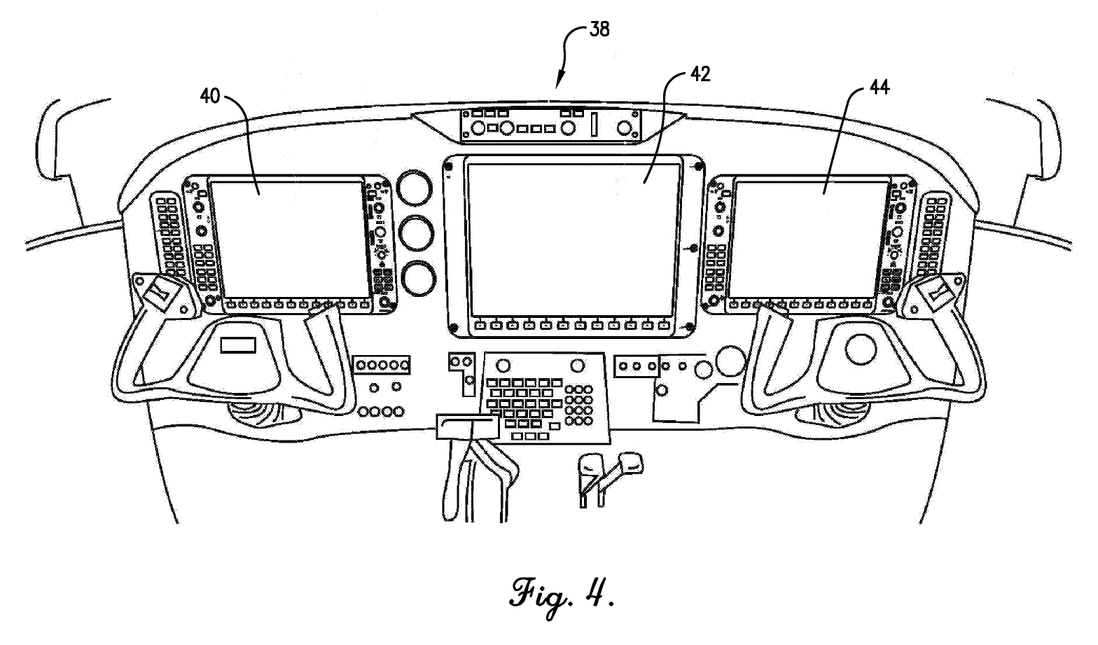

The user interface 24 enables pilots, co-pilots, and other users to view received text-based messages and interact with the system 10. An exemplary user interface 24 may include one or more interactive displays such as the display 36 illustrated in FIG. 3. The display 36 includes a display screen and/or a plurality of knobs, buttons, or similar user interface elements operable to allow a pilot or co-pilot to interact with, and submit information to, the system 10. The display screen 36 may include touch-screen technology in addition to or in place of the knobs, buttons, or similar user interface elements. The display 36 may be a stand-alone unit or an integrated display 40, 42, or 44 associated with a flight deck 38 of one of the aircraft 12, 14 as illustrated in FIG. 4. The user interface 24 may include multiple displays, such as a first primary flight display 40, a multi function display 42, and a second primary flight display 44. In addition to the messages and other information of the present technology, the displays 40, 42, 44 may present primary flight, navigation, weather, terrain, traffic, radio frequency, and engine data.

The global positioning component 26 may include a global navigation satellite system (GNSS) receiver such as a global positioning system (GPS) receiver, a Glonass receiver, a Galileo receiver, a Compass system receiver or any other device that can determine locations of an aircraft in which the system 10 is used. The global positioning component 26 may be, for example, a GPS receiver much like those provided in products by GARMIN INTERNATIONAL, INC., of Olathe, KS, and disclosed in U.S. Pat. No. 6,434,485, which is incorporated herein by specific reference in its entirety.

The global positioning component 26 receives spread spectrum navigation signals from a plurality of satellites 46 as shown in FIG. 2 and calculates the system's current location as a function of these signals. The global positioning component 26 may include one or more processors, controllers, or other processing systems and memory. Alternatively, the global positioning component 26 may utilize the components of the processing system 18. The memory 28 or other memory may store cartographic data and routing information used by or generated by the global positioning component 26. The memory 28 may be integral with the global positioning component 26, integral with the processing system 18, stand-alone memory, or a combination of both. The global positioning component 26 may also include an internal or external antenna to assist in receiving the navigation signals from the satellites 46.

The input device 30 allows pilots, co-pilots, or other users to input information into the system 10 or otherwise operate or interact with the system 10. In some configurations, the input device 30 comprises a portion of the user interface 24. The input device 30 may comprise any number and type of knobs, button, switches, dials, etc., and may be a part of the user interface 24 or a stand-alone device. The printer 32 allows printing of messages received by the system and may be any conventional printing device.

The above-described system 10 may be used by pilots, co-pilots, or other operators of aircraft 12, 14 equipped with the system 10 to receive and analyze CPDLC messages and/or other text-based messages. The user interface 24, input device 30, or other component of the system 10 may provide functionality enabling a user to select whether to identify and/or present text-based messages intended for his or her aircraft, other aircraft, ground stations, or some combination thereof. For example, the input device 30 may include a toggle switch, dial, or other switch that may be selectively positioned between an “Ownship” position, which causes the processing system 18 to filter out all messages except those intended for the operator's own aircraft, and an “All” position, which instructs the processing system 18 to identify all messages, including those intended for other aircraft. In some embodiments, the user interface 24, input device 30, or other component of the system 10 may provide functionality that causes to processing system 18 to identify and/or present messages intended for the operator's own aircraft and certain selectable other aircraft.

The input device 30 may also be configured to cause the processing system 18 to identify and/or present messages corresponding to only certain aircraft. For instance, the processing system 18 may be configured to identify messages for only nearby aircraft, for only aircraft on the same approach path, for only aircraft at the same altitude, heading, and/or speed, combinations thereof, and the like. In some embodiments, the pilot may designate one or more particular aircraft using the user interface 24, such as by selecting an aircraft from among those presented a traffic display, to cause CPDLC messages for that particular aircraft to be identified, monitored, displayed, or otherwise processed by the processing system 18.

When a user instructs the processing system 18 to accept messages belonging to other aircraft, these messages may be displayed on a portion of one of the displays 36, 40, 42, or 44 as depicted in FIG. 3. The processing system 18 may also associate the received messages with aircraft for which they are intended. It is common for modern aircraft to be assigned a unique International Civil Aviation Organization (ICAO) 24 bit address upon registration and this address is included in some types of communications transmitted to and from the aircraft. The processing system 18 may compare the ICAO address of a received message to known ICAO addresses to identify the aircraft for which the message is intended and then display identification information and/or message for the intended aircraft.

In one embodiment, the processing system 18 associates received messages with particular aircraft by analyzing both the received messages and position data received from the other aircraft. ADS-B position data transmitted from aircraft includes the source aircraft's ICAO address. The processing system 18 may receive ADS-B position data from other aircraft, identify the ICAO addresses for each aircraft, determine which of these aircraft are within a selected distance of the user's aircraft based on position information calculated by the global positioning component 26, and then use the ICAO addresses of nearby aircraft to filter displayed messages based on the ICAO addresses for nearby aircraft. For example, once the global positioning component 26 determines the current location of the aircraft in which it is mounted, the processing system 18 may display messages for other aircraft that are within a certain radius of the aircraft, such as a 20 mile radius. In addition to, or instead of, ADS-B information, the processing system 18 may use TCAS, transponder, and/or other position information for nearby aircraft to associate received messages with nearby aircraft.

The processing system 18 may also display location information for the other aircraft and permit a user to view messages intended for a particular aircraft. As shown in FIG. 3, the processing system 18 or another component may display an ownship screen 47 that includes a graphical representation 48 of the user's own aircraft next to graphical representations 50, 52 of other aircraft such as the other aircrafts' traffic symbols. A user may touch, point to, highlight, or otherwise select the graphical representation of another aircraft to prompt the processing system 18 to display all messages 54 intended for that aircraft. In some embodiments, a user may select more than one aircraft to prompt the processing system 18 to identify and/or present all messages 54 intended for selected aircraft. The identified text-based messages may be filtered by searching for one or more keywords.

In some configurations, the screen 47 may present a 3D globe upon which geo-referenced representations of the user's own aircraft 48 and other aircraft 50, 52 are displayed. The 3D globe may include weather overlays, traffic overlays, cartographic information (e.g., terrain data, approach and airport information, etc.), combinations thereof, and the like. The 3D globe may easily be manipulated by touch or other controls to rapidly and intuitively select aircraft representations 50, 52 and review messages associated with the aircraft. For example, a pilot or other user could “hover” over the graphical representation of another aircraft and read some or all messages intended for that aircraft. The 3D globe interface may also be utilized to designate particular aircraft for CPDLC message monitoring.

As mentioned above, the processing system 18 may also store received messages in the memory 28 or other memory, and a user may retrieve and view the messages at a later time. A user may also enter or select certain keywords such as “turbulence”, “icing”, “delay”, “abort”, or “deviation” with the user interface 24 or input device 30 to instruct the processing system 18 to search for and display all stored messages with these keywords. The processing system 18 may also automatically analyze received messages in substantial real-time and display messages that contain certain keywords or phrases. In some embodiments, the processing system may alert a user that a text-based message containing certain keywords or phrases has been identified through the user interface 24. For example, the processing system 18 may automatically identify and alert a user that a nearby aircraft is experiencing turbulence based on the content of messages directed to the nearby aircraft. Other situations that may be automatically identified by the processing system 18 by parsing received text-based messages include: weather information; conditions at nearby airports; delays and other scheduling issues associated with aircraft and airports; combinations thereof; and the like.

Further, text-based messages corresponding to several aircraft may be simultaneously monitored to develop situational information. For example, CPDLC reports of turbulence from multiple aircraft may be utilized to provide more complete information regarding the location and nature of the reported turbulence. Similarly, statistical delay and other scheduling information may be generated by monitoring CPDLC messages corresponding to multiple aircraft. In some embodiments, an aircraft may develop situational information by receiving and processing meteorological and/or turbulence information collected and communicated by other aircraft. For example, other aircraft may collect meteorological information (e.g., air temperature, precipitation, pressure, etc.) and turbulence information (e.g., measurement of impact of meteorological elements on the aircraft) and communicate that information to remote radio systems. The other aircraft may broadcast collected information or communicate it to remote radio systems in response to requests for the collected information.

In some embodiments, the processing system 18 may delete the stored messages periodically such as every hour, day, or month. Stored messages may be analyzed for data gathering and analysis purposes. In some embodiments, the system 10 may identify recurring events using the stored messages and notify the user of anticipated issues. For example, the system 10 may identify that an airport frequently visited by an aircraft encounters delays at a certain time and notify a user of the identified issue if the aircraft is headed in the direction of the airport. A user may also direct the processing system 18 to print certain messages with the printer 32.

In some embodiments, the system 10 may also be coupled with or integrated into an aircraft's flight management system 34 to automate certain tasks in accordance with received text-based messages. For example, the FMS may automatically calculate a course to follow based on text-based routing instructions received by the system 10.

The flow chart of FIG. 5 shows the functionality and operation of an exemplary method 500 of the present technology. In this regard, some of the blocks of the flow chart may represent a step in the method 500 and/or a module segment or portion of code of computer programs. In some alternative implementations, the functions noted in the various blocks may occur out of the order depicted in FIG. 5. For example, two blocks shown in succession in FIG. 5 may in fact be executed substantially concurrently, or the blocks may sometimes be executed in the reverse order depending upon the functionality involved.

The method 500 begins when the system 10 receives one or more text-based messages transmitted by a plurality of remote radio systems as depicted in box 502. The system then receives position data for the target remote radio system as depicted in box 504. The system then associates the received messages with the aircraft or ground station transmitting and/or receiving the text-based message as depicted in box 506. In some embodiments, this may be done by comparing the ICAO addresses accompanying the received text-based messages with the ICAO addresses accompanying the position data as described above. The system then presents, stores, and/or prints the received messages along with identifiers for the target remote radio system and/or all remote radio systems involved in the communication of the text-based message as depicted in box 508.

Although embodiments of the invention has been described with reference to the embodiments illustrated in the attached drawing figures, those of ordinary skill in the art will appreciate that an arrangement calculated to achieve the same results can be substituted for the specific examples shown.

Having thus described the preferred embodiment of the invention, what is claimed as new and desired to be protected by Letters Patent includes the following:

1. A system for receiving text-based messages in an aircraft, the system comprising:
a radio operable to receive the text-based messages transmitted by a plurality of remote radio systems;
a processing system operable to determine which of the text-based messages are intended for a target remote radio system based on information in the text-based messages; and
a user interface operable to permit an operator of the aircraft to monitor the text-based messages intended for the target remote radio system.

2. The system as set forth in claim 1, wherein the target remote radio system is one of a ground station or other aircraft.

3. The system as set forth in claim 2, the user interface comprising a display that displays the text-based messages intended for the target remote radio system and associates the text-based messages with an identifier for the target remote radio system.

4. The system as set forth in claim 3, wherein the identifier for the target remote radio system is one of a radio identification information, an ICAO address, flight number, airline, or tail number.

5. The system as set forth in claim 3, wherein the identifier for the target remote radio system includes a representation of the target remote radio system's position displayed on the display.

6. The system as set forth in claim 5, wherein the display is a touchscreen display and the processing system is operable to display the text-based messages intended for the other aircraft when the operator touches the representation of the target remote radio system displayed on the display.

7. The system as set forth in claim 1, further comprising memory coupled with the processing system for storing the text-based messages transmitted by the plurality of remote radio systems.

8. The system as set forth in claim 7, wherein the processing system is operable for searching for keywords in the stored text-based messages.

9. The system as set forth in claim 8, wherein the user interface further comprises an input device for permitting the operator to input the keywords.

10. The system as set forth in claim 1, wherein the target radio system is one of the plurality of remote radio systems.

11. A system for receiving and analyzing controller pilot data link communications (CPDLC) messages in an aircraft, the system comprising:
a radio operable for receiving CPDLC messages from transmitted by a plurality of remote radio systems;
a radio operable for identifying position data for at least one target remote radio system;
a processing system operable for associating the CPDLC messages with a target remote radio system based on information in the CPDLC messages and the position data; and
a display operable for displaying the CPDLC messages intended for the target remote radio system in association with an identifier for the target remote radio system.

12. The system as set forth in claim 11, wherein the identifier for the target remote radio system is one of a radio identification number, an ICAO address, flight number, airline, or tail number for the target remote radio system.

13. The system as set forth in claim 11, wherein the identifier for the target remote radio system includes a representation of the target remote radio system's position displayed on the display.

14. The system as set forth in claim 13, wherein the display is a touchscreen display and the processing system is operable to display the CPDLC messages intended for the target remote radio system when an operator touches the representation of the target remote radio system displayed on the display.

15. The system as set forth in claim 11, further comprising memory for storing the CPDLC messages intended for the plurality of remote radio systems.

16. The system as set forth in claim 15, wherein the processing system is operable for searching for keywords in the stored CPDLC messages.

17. The system as set forth in claim 16, further comprising an input device for permitting the operator to input the keywords.

18. A system for receiving and analyzing controller pilot data link communications (CPDLC) in an aircraft, the system comprising:
a radio operable for receiving CPDLC messages from a plurality of remote radio systems;
a radio operable for receiving automatic dependent surveillance-broadcast (ADS-B) position data from a plurality of remote radio systems;
a global navigation satellite system receiver operable for receiving navigation signals from satellites;
a processing system operable for determining a position of the aircraft based on the navigation signals and for associating received CPDLC messages from a target remote radio system based on information in the CPDLC messages and the ADS-B position data received from the target radio system; and
a display for displaying the CPDLC messages intended for the target remote radio system and an identifier for the target remote radio system.

19. The system as set forth in claim 18, wherein the identifiers for the other aircraft is one of a radio identification information, an ICAO address, flight number, airline, tail number, or a representation of the target remote radio system's position.

20. The system as set forth in claim 19, wherein the display is a touchscreen display and the processing system is operable to display the CPDLC messages intended for the target remote radio system when an operator touches the representation of the target remote radio system displayed on the display.

21. The system as set forth in claim 18, further comprising memory for storing the CPDLC messages intended for the target remote radio system.

22. The system as set forth in claim 21, wherein the processing system is operable for searching for keywords in the stored CPDLC messages.
